(19) United States
(12) Patent Application Publication
(10) Pub. No.: US 2005/0038682 A1
(43) Pub. Date: Feb. 17, 2005

(54) Method and systems for virtual insurance adjusting

(76) Inventors: Gregory M. Gandee, Lorton, VA (US); Gary L. Conner, Ashburn, VA (US)

Correspondence Address: BURNS DOANE SWECKER & MATHIS L L P, POST OFFICE BOX 1404, ALEXANDRIA, VA, 22313-1404, US

(21) Appl. No.: 10/682,998

(22) Filed: Oct. 14, 2003

Related U.S. Application Data
(60) Provisional application No. 60/494,956, filed on Aug. 14, 2003.

(51) Int. Cl. G06F 17/60

(52) U.S. Cl. 705/4

(57) ABSTRACT

Methods and systems for insurance adjusting for property casualty losses are provided. A communication link is established between the location of the property casualty loss and an insurance company. The communication link can provide real-time audio and visual communications between the insurance company, the owner of the property which suffered the casualty loss and a third party. The insurance company can receive visual identification of the property casualty loss without actually visiting the property, thereby reducing costs to the insurance company.

### RELATED APPLICATIONS

The present application claims priority under 35 U.S.C. § 119(e) to U.S. Provisional Application No. 60/494,956 entitled “Method and Systems for Virtual Insurance Adjusting” by Gregory Gandee et al. filed on Aug. 14, 2003, the entire disclosure of which is herein expressly incorporated by reference.

### BACKGROUND

Property owners typically, and in most cases are required by their mortgage company to, insure their property against casualty losses. To collect on an insurance policy from an insurance company the property owner (i.e., the insured) must submit a claim. Depending upon the nature of the claim for casualty loss, the insurance company may either pay the claim based upon the property owner's representation of the casualty loss or send an insurance adjuster to the property to assess the casualty loss. Since the use of insurance adjusters increase an insurance company's costs, an insurance adjuster will typically only be sent to the property for assessing the casualty losses when the claim is above a certain dollar amount.

Although an insurance company is typically liable for the casualty loss itself, the property owner is required to attempt to mitigate the damages caused by the casualty loss. For example, if a hot water heater breaks and water damages carpets on the property, the property owner should attempt to have the water removed from the carpet immediately to reduce the risk that the entire carpet would need to be replaced. For these types of situations an insurance company typically requests that the property owner contact a mitigation company. A mitigation company is a company which can address a casualty loss to prevent additional damages from occurring. A mitigation company can be distinguished from other companies which perform work on damaged properties since the mitigation company performs repairs and other services to mitigate the damage, while other companies which perform work on damaged properties perform restoration work to place the damaged property into the condition which existed prior to the property casualty loss. The mitigation company will visit the property, mitigate damages, and report their findings to the insurance company. In many instances, based on the size and nature of the loss, an adjuster will be required to perform an on-site visit to the property in order to make decisions about coverage. Some claims, such as fire/smoke damage, should benefit from immediate emergency cleaning. However, most insurance companies require an on-site visit to a large loss before allowing restoration work to begin. This procedure introduces delay into the process before the property can be repaired which could increase the amount of damages under the claim. Accordingly, the on-site visit is for the purposes of assessing the damage in order to authorize restoration work, as compared to mitigation work which typically does not require an on-site assessment prior to the authorization of mitigation work.

To reduce operating costs, insurance companies are consolidating local and regional offices and reducing the number of adjusters. This reduction in the number of claims adjusters has increased the workload on the remaining adjusters, thereby leading to an increase in the number of potential fraudulent claims filed. Additionally, due to the reduction of insurance adjusters, insurance companies are not conducting proper subrogation investigations, thereby resulting in an increased financial burden of the claims on the insurance companies.

The reduction of claims personnel has also led to confusion as to what is covered by an insurance policy, and the insured's rights and obligations under that policy. The property owner's confusion can be increased when a mitigation company is the first to respond. Specifically, the property owner may ask the mitigation company questions about the insurance policy. Since the mitigation company is not aware of the details of each insurance policy, the mitigation company cannot answer these questions, leaving the property owner frustrated. This confusion and other miscommunications, heightened by the fact that the insurance company is not represented early on, results in dissatisfaction of the property owner with the insurance company, and may result in the property owner switching insurance companies. The loss of customers due to this type of confusion increases costs to insurance companies which have to spend more money to bring in new property owners to replace those who left.

### SUMMARY

Methods and systems for insurance adjusting for property casualty losses are provided. A communication link is established between the location of the property casualty loss and an insurance company. The communication link can provide real-time audio and visual communications between the insurance company and the owner of the property which suffered the casualty loss. The insurance company can receive visual verification of the property casualty loss without actually visiting the property, thereby reducing costs to the insurance company and providing better customer service. This “virtual adjusting” eliminates travel time and allows the adjuster to handle claims more efficiently, while providing better customer service.

### BRIEF DESCRIPTION OF THE DRAWINGS

The accompanying drawings provide visual representations which will be used to more fully describe the representative embodiments disclosed herein and can be used by those skilled in the art to better understand them and their inherent advantages. In these drawings, like reference numerals identify corresponding elements and:

FIG. 1 illustrates an exemplary system for adjusting property casualty losses in accordance with the present invention; and

FIG. 2 illustrates an exemplary method for adjusting property casualty losses in accordance with the present invention.

### DETAILED DESCRIPTION

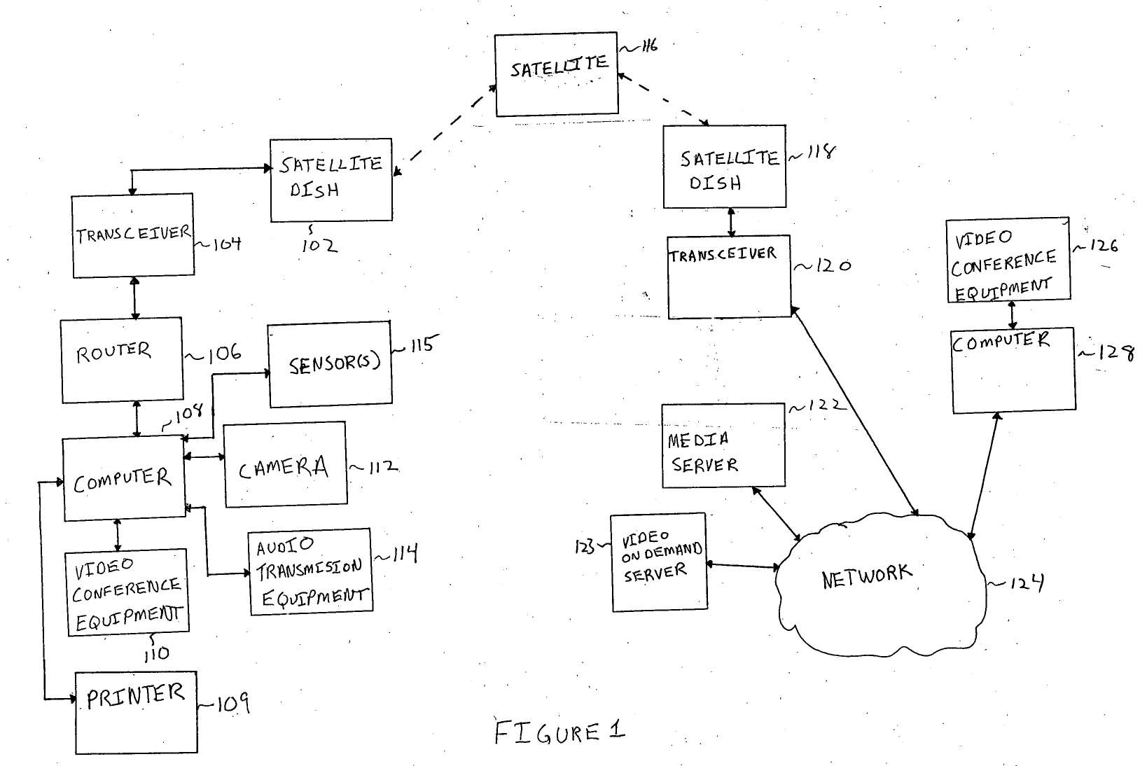

FIG. 1 illustrates an exemplary system for a virtual adjustment of property casualty losses in accordance with the present invention. In accordance with exemplary embodiments of the present invention a virtual adjuster arrives at a property which has suffered a casualty loss. The virtual adjuster brings a satellite dish 102, transmitter/receiver (transceiver) 104, router 106, computer 108, printer 109, video conference equipment 110, camera 112, audio transmission equipment 114, and one or more sensors 115.

The satellite dish can be any type of satellite dish which allows for the transmission and reception of signals with a satellite, such as the SWE-DISH Drive-Away 150 KM produced by SWE-DISH Satellite Systems of Stockholm Sweden. This satellite dish is designed for rooftop mounting on a vehicle. While the vehicle is in motion the satellite dish is stored in the rooftop mount. When satellite communications are desired, the satellite dish can automatically be deployed and pointed towards a desired satellite. SWE-DISH Satellite Systems sells a GPS/Compass system which provides automatic satellite locating and signal acquisition which can be used with the SWE-DISH Drive-Away 150 KM.

The transceiver 104 can be any type of terminal or modem which is capable of communicating with a satellite via a satellite dish and which can provide the received information to a computer 108 or to a router 106 in the form of, for example, Internet Protocol (IP) data packets. One such transceiver is the LinkStar Satellite IP Terminal manufactured by ViaSat.

Router 106 can be a wired or wireless network hub or router which provides information received from the transceiver 104 to a computer 108. For example, router 106 can be a Dual-Band Wireless A+B Broadband Router Model No. WRT51AB manufactured by Linksys. If router 106 is a wired router, or if wireless communications cannot be performed between router 106 and computer 108, networking cable such as CAT5 cable is employed between the router 106 and computer 108.

Computer 108 can be a portable computer such as a notebook or a tablet computer. The computer 108 includes a wireless access port, a wired Ethernet port, or both for interfacing with router 106. The wireless access port and the wired Ethernet port can be either built into the computer 108, or can be added using, for example, PCMCIA cards. One example of a PCMCIA card for a wireless access port is the Wireless-G Notebook Adapter manufactured by Linksys. The computer 108 can run any type of operating system, such as Microsoft Windows XP. Additionally, the computer 108 may include software which allows the virtual adjuster to fill out an electronic work order for the initial mitigation work which can be provided to the insurance company over the communication link. Additionally, the work order or a check to the insured can be printed locally via an attached or wireless printer 109.

Connected to computer 108 is video conference equipment 110 for providing real-time audio and visual communication between the users of the computer 108 and computer 128. Real-time audio and visual communication is a communication in which one or more of the parties of the communication receives audio and visual information from another party substantially as it is captured, with any delay introduced by the communication medium. The video conference equipment can include one or more video cameras, a microphone and a speaker. The computer 108 includes software which facilitates the video conference between computer 108 and computer 128. One example of video conference equipment and software which provides these features is ViGO by VCON. Video conference equipment 126 can be the same type of equipment as video conference equipment 110. Accordingly, video conference equipment 126 can include a video camera, microphone, speakers and computer software.

One or more cameras 112 are employed for providing images of the damaged areas of the property to the insurance company. Camera 112 can be either a camera capable of capturing still images, such as a digital camera, a camera capable of capturing moving images, such as a video camera, or a camera capable of capturing still and moving images. An exemplary video camera is the DCR TRV80 MiniDV Handycam Camcorder by Sony which can provide both still images, and video images which can be streamed over a USB connection to a computer. Audio transmission equipment 114 provides for the transmission and reception of audio information from the user of computer 108 to allow the user of computer 128 to request that the camera 112 capture images of particular portions of the damaged property, and provide direct communication between the adjuster and property owner. Although illustrated as a separate element, audio transmission equipment 114 can be part of video conference equipment 110, such as the wireless audio transmission equipment which is included in the aforementioned ViGO video conference equipment. Additionally, camera 112 can be a component of video conference equipment 110.

Sensors 115 can be digital or analog sensors. For example, these sensors can be temperature sensors, relative humidity sensors, and the like.

Satellite 116 can be any type of satellite which is capable of transmitting and receiving information from ground based satellite dishes. Media server 122 provides a video phonebook capability to support automated call routing between computer 108 and computer 128, and can also be used to configure and monitor a communication link between computers 108 and 128. The monitoring can include recording the amount of time during which the communication link between computers 108 and 128 is used, or the amount of data exchanged between computers 108 and 128, and/or the communications between computers 108 and 128. This monitoring information can be used to bill the insurance company for the cost of the communication link.

Video on demand server 123 can record and playback the audio visual communications between computers 108 and 128. Network 124 can be any type of voice or data network, or a direct T1 connection, and in an exemplary embodiment is the Internet. Computer 128 can be any type of conventional computer, including a desktop computer, a laptop computer, or the like. Although not illustrated in FIG. 1, a communication link can be provided between network 124 and a conference room with video conference equipment. This is especially useful for large scale disaster situations and for training insurance personnel.

Satellite dish 118, transceiver 120 and media server 122 can be owned or leased, and operated by the virtual adjuster company.

To receive the audio and visual information from the property which suffered the casualty loss the insurance company requires only a standard computer 128, video conference equipment 126 and access to a network 124, e.g., the Internet.

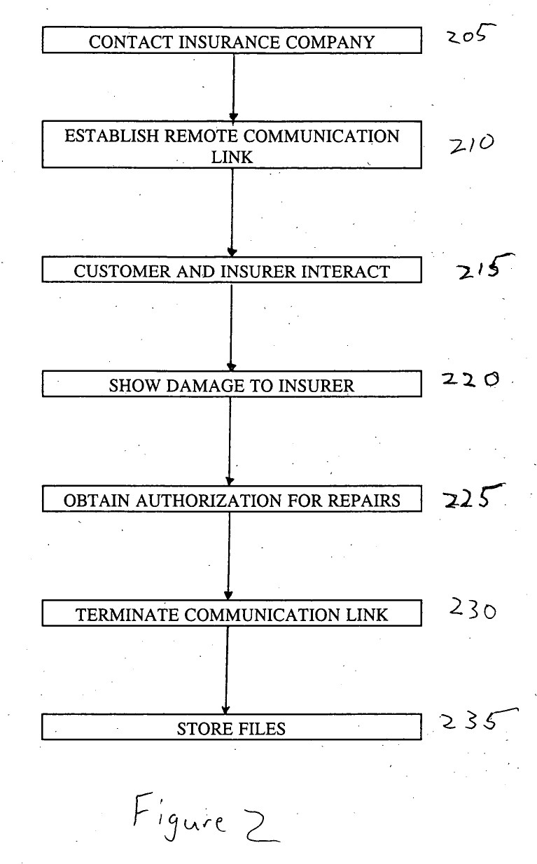

FIG. 2 illustrates an exemplary method for insurance adjusting for property casualty losses. When the virtual adjuster arrives at the location of the property casualty loss, the insurance company will be contacted and informed of the intention to establish a live audio visual communication link. (Step 205). This contact can be performed using a wireless phone, a land line phone and/or electronic mail. The virtual adjuster then deploys satellite dish 102 which is aimed, either manually or automatically, at satellite 116. The communication link is then established between satellite dish 102 and satellite dish 118 via satellite 116. At the same time, or shortly thereafter, a communication link is established between satellite dish 118 and computer 128, thereby forming a seamless real-time audio and visual communication link between computers 108 and 128. (Step 210).

Once the communication link has been completed between computers 108 and 128, an insurance adjuster, or other agent of the insurance company, can consult with the property owner regarding the terms of the insurance policy. (Step 215). Once the insurance adjuster at computer 128 has finished discussing the terms of the policy with the property owner, the insurance adjuster can then discuss the damage to the property with the virtual adjuster and, if present, the mitigation company. (Step 220). Specifically, the insurance adjuster can request video of the damaged area or other information such as the temperature or relative humidity. The virtual adjuster can capture and transmit these images using camera 112. The virtual adjuster communicates with the insurance adjuster using audio transmission equipment 114.

In addition to requesting video of the damage to the property, the insurance adjuster can request video of the source of the damage for any possible subrogation claim. For example, if the property damage is caused by a water heater which has burst, the serial number of the water heater, or other identifying information, can be obtained. The serial number of the water heater can be used to determine whether the water heater is still covered under a warranty. If so, the insurance company may seek subrogation for the property damage from the manufacturer of the water heater.

The insurance adjuster can also provide immediate authorization for the mitigation company to perform the repairs. (Step 225). Once the communication between the insurance company adjuster and the virtual adjuster and/or the property owner has finished, the entire communication, (including audio, video and any other data exchanged), can be stored. (Steps 230 and 235). This information can be stored by the video on demand server 123 or by computer 128, or by another element at the insurance company such as a network storage device.

Although FIG. 2 illustrates performing steps in a particular order, these steps need not be performed in this order. For example, the mitigation company can show the damage to the insurer (step 220) prior to the customer and the insurance company interacting (step 215). Additionally, certain steps can be omitted. For example, if the customer does not require clarification of the rights and obligations under the policy, the customer need not interact with the insurer (step 215). Moreover, it is not necessary to store the files (step 235).

The present system provides a number of advantages over conventional techniques for insurance adjusting for property casualty losses. Since the virtual adjuster will typically be the first party to visit a property which has suffered a casualty loss, by providing equipment for the virtual adjustment service, the virtual adjuster provides a valuable service to insurance companies. Specifically, an insurance company can save money by reducing the amount of travel time for insurance adjusters, and increase the number of claims handled by an insurance adjuster, since the insurance adjuster can establish a virtual presence at the property of the casualty loss without leaving their desk. Additionally, insurance companies may retain more customers since they can provide a virtual presence, and hence, provide an explanation of coverage reducing confusion and distrust between the insurance company and its customers. The risk of fraud to insurance companies can be reduced since they can “see” and record the damage of many more property casualty losses, instead of only visiting losses which exceed a certain dollar amount. Insurance companies can reduce their losses for claims by increasing their own claims for subrogation. Customers of insurance companies also benefit since the mitigation company can immediately begin mitigation, instead of waiting for an insurance adjuster to visit the property.

Although exemplary embodiments of the present invention have been described as employing specific components, it should be recognized that other equivalent components can be employed. For example, a laptop computer may have a built-in video camera, microphone and speakers. Accordingly, the video conference equipment would comprise video conferencing software, and if desired camera 112 and audio transmission equipment 114 can be omitted since these functions are provided by the computer. Additionally, a Personal Digital Assistant (PDA), wireless phone or other type of device equipped with a camera may be used in place of camera 112 and audio transmission equipment 114, and/or computers 108 and 128.

Although exemplary embodiments have been described as employing a single real-time audio and visual communication link between the location of the property casualty loss and the insurance company, multiple communication links may be employed. For example, the video conferencing between the computers 108 and 128 can employ the satellite communication link while pictures captured by camera 112 and the communications using audio transmission equipment 114 can occur over a conventional wireline or wireless (e.g., radio frequency (RF), laser, cellular or PCS) communication network, or satellite using voice over IP (VOIP).

In the description above the real-time audio and visual communication link between the location of the property casualty loss and the insurance company has been described in exemplary embodiments as including a satellite communication link. However, any type of high speed communication link which can support real-time audio and visual communication can be used. For example, some third generation cellular communication networks support high speed data communication links. Additionally, some areas may have wireless RF type systems which can support high speed data communication links. Moreover, if the location of the property casualty loss has a wired high speed communication link, such as ISDN, DSL, or a cable modem, these wired communication links can be used in place of the satellite communication link.

For ease of explanation the property owner and the insured party under an insurance policy (i.e., the customer) are treated as the same entity. However, these may in fact be separate entities. If this is the case then the insured party would be the one who performs the actions described above as being performed by the property owner in connection with the mitigation company or the insurance company.

Property casualty losses typically include losses to real property and attachments thereto (such as buildings), losses to automobiles, boats and other types of property. The use of mitigation companies is typically limited to property casualty losses to real property and attachments thereto. For the purposes of the present application the phrase property casualty loss should be interpreted as casualty losses to real property and attachments thereto, the contents of the real property or attachments, losses to automobiles, boats and other types of property.

In addition to the virtual adjustment service described above, the present invention is applicable in other areas. For example, the system can be used for performing property appraisals and for property inventories.

For ease of explanation the exemplary embodiments have been described in which a virtual adjuster provides the equipment and performs actions in connection with the virtual adjustment. The virtual adjuster can be a mitigation company. Furthermore, the virtual adjuster can be any third party which provides the equipment and perform the actions. For example, a company can be set up to primarily provide the virtual adjustment services in a franchising system where franchisees provide the virtual adjustment services in specific geographic areas designated by a franchisor. As referenced herein, a third party includes a mitigation company, the above-mentioned franchisee, or any other party which is neither the insurance company nor the insured.

It will be appreciated by those of ordinary skill in the art that the present invention can be embodied in various specific forms without departing from the spirit or essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

1. A method for insurance adjusting for property casualty losses comprising:
initiating a real-time audio and visual communication link between a location of a property casualty loss and an insurance company;
allowing a customer of the insurance company to communicate with the insurance company over the communication link;
providing visual identification of the property casualty loss over the communication link; and
obtaining authorization for repairs of the property casualty loss based upon the visual identification.

2. The method of claim 1, wherein the communication link comprises a wireless communication link.

3. The method of claim 2, wherein the wireless communication link comprises a satellite communication link.

4. The method of claim 3, wherein the communication link further comprises a data communication link.

5. The method of claim i, wherein the communication between the customer and the insurance company is initiated by a mitigation company and the authorization for repairs are for restoration work to the property.

6. The method of claim 1, wherein the communication between the customer and the insurance company is initiated by a third party.

7. The method of claim 1, wherein the visual portion of the audio-visual communication employs a separate visual capture device than employed for providing the visual identification of the property casualty loss.

8. The method of claim 1, further comprising:
recording and monitoring usage of the communication link; and
billing the insurance company for the usage of the communication link.

9. The method of claim 8, wherein the usage is based on an amount of data carried over the communication link.

10. The method of claim 8, wherein the usage is based on an amount of time in which the communication link is used.

11. The method of claim 1, wherein the communication link comprises a first communication link and a second communication link, the first communication link is employed for allowing the customer to communicate and the second communication link is employed for providing the visual identification.

12. A method for insurance adjusting for property casualty losses comprising:
establishing a real-time audio and visual communication link between an insurance company and a location of a property casualty loss;
communicating with a customer of the insurance company over the communication link;
requesting visual identification of the property casualty loss;
receiving the visual identification over the communication link; and
providing authorization for repairs for the property casualty loss.

13. The method of claim 12, wherein the communication link comprises a wireless communication link.

14. The method of claim 13, wherein the wireless communication link comprises a satellite communication link.

15. The method of claim 14, wherein the communication link further comprises a data communication link.

16. The method of claim 12, wherein equipment at the location of the property casualty loss for establishing the communication link is provided by a mitigation company.

17. The method of claim 12, wherein equipment at the location of the property casualty loss for establishing the communication link is provided by a third party.

18. The method of claim 12, further comprising:
receiving a bill for usage of the communication link.

19. The method of claim 12, wherein the communication link comprises a first communication link and a second communication link, the first communication link is employed for allowing the customer to communicate and the second communication link is employed for providing the visual identification.

20. The method of claim 12, further comprising:
storing data received over the communication link.

21. The method of claim 12, further comprising:
requesting visual identification of a source of the property casualty loss.

22. The method of claim 21, wherein the visual identification of the source of the property casualty loss is employed in obtaining subrogation of an insurance claim based on the property casualty loss.

23. A system for insurance adjusting for property casualty losses comprising:
a satellite dish;
a transceiver connected to the satellite dish;
a computer connected to the transceiver; and
audio and visual equipment connected to the computer, wherein the computer displays real-time audio and visual information received from an insurance company via the satellite dish, and the audio-visual equipment provides real-time audio and visual communication between a customer of the insurance company and the insurance company, and provides real-time video of the customer's damaged property.

24. The system of claim 23, wherein the audio and visual equipment comprises video conference equipment which provides the audio and visual communication between a customer of the insurance company and the insurance company, and a camera provides the video of the customer's damaged property.

25. The system of claim 24, wherein the camera is a video camera which captures motion images.

26. The system of claim 25, wherein the video camera also captures still images.

27. The system of claim 23, further comprising:
a router which connects the computer to the transceiver.

28. The system of claim 23, wherein the computer is a laptop computer, a tablet computer, or a personal digital assistant.

29. The system of claim 23, wherein the satellite dish, the transceiver, the computer and the audio-visual equipment is operated by a mitigation company.

30. The system of claim 23, wherein the satellite dish, the transceiver, the computer and the audio-visual equipment is operated by a third party.

31. The system of claim 23, wherein the computer comprises a user interface which provides real-time audio and visual communication between the customer and the insurance company.

32. A system for insurance adjusting for property casualty losses comprising:
a satellite dish;
a transceiver connected to the satellite dish; and
a server connected to the transceiver and a network,
wherein the satellite dish receives real-time audio and visual information from a property insured by an insurance company and transmits real-time audio and visual information received from the insurance company, and
wherein the server determines an amount of usage of a communication link comprising the satellite dish, a satellite and another satellite dish.

33. The system of claim 32, wherein the network is the Internet.

34. The system of claim 32, wherein the server establishes the communication link.

35. The system of claim 32, wherein the satellite dish and the transceiver are operated by a third party.
